(19) United States
(12) Patent Application Publication
(10) Pub. No.: US 2015/0014277 A1
(43) Pub. Date: Jan. 15, 2015

(54) INTERCHANGEABLE SWITCHING MODULE AND ELECTRICAL SWITCHING APPARATUS INCLUDING THE SAME

(71) Applicant: EATON CORPORATION, CLEVELAND, OH (US)

(72) Inventors: PETER JOHN THEISEN, WEST BEND, WI (US); PAUL JASON ROLLMANN, BROWN DEER, WI (US); MARK ALLAN JUDS, NEW BERLIN, WI (US); THOMAS JOHANN SCHOEPF, WHITEFISH BAY, WI (US); XIN ZHOU, FRANKLIN PARK, PA (US)

(73) Assignee: EATON CORPORATION, CLEVELAND, OH (US)

(21) Appl. No.: 13/942,083

(22) Filed: Jul. 15, 2013

(51) Int. Cl. H01H 33/02

(52) U.S. Cl. CPC H01H 33/02
USPC 218/1

(57) ABSTRACT

An interchangeable switching module is for an electrical switching apparatus including a first enclosure, separable contacts and an operating mechanism structured to open and close the separable contacts. The interchangeable switching module includes a second enclosure structured to fit within the first enclosure of the electrical switching apparatus; and an interchangeable electrical circuit and/or mechanical mechanism within the second enclosure and being structured to cooperate with switching of the separable contacts.

### BACKGROUND

1. Field

The disclosed concept pertains generally to electrical switching apparatus and, more particularly, to electrical switching apparatus, such as, for example, circuit breakers. The disclosed concept also pertains to switching modules for such apparatus.

2. Background Information

Electrical switching apparatus employing separable contacts exposed to air can be structured to open a power circuit carrying appreciable current. These electrical switching apparatus, such as, for instance, circuit breakers, typically experience arcing as the contacts separate and commonly incorporate arc chambers, such as arc chutes, to help extinguish the arc. Such arc chutes typically comprise a plurality of electrically conductive arc plates held in a spaced relation around the separable contacts by an electrically insulative housing. The arc transfers to the arc plates where it is stretched, split and cooled until extinguished.

Electrical switching apparatus, such as circuit breakers, are used for direct current (DC) and/or alternating current (AC) applications. One of the challenges in DC current interruption/switching, especially at a relatively low DC current, is to drive the arc into the arc chamber. Known DC electrical switching apparatus employ permanent magnets to drive the arc into arc splitting plates.

A known problem associated with such permanent magnets in known DC electrical switching apparatus is unidirectional current flow operation of the DC electrical switching apparatus. A proposed solution to provide bi-directional current flow operation in a DC switching device, such as a molded case circuit breaker (MCCB) or a miniature circuit breaker (MCB), is a double-break design (e.g., similar to the contact structure of a contactor) including two sets of contacts, and two separate arc chambers with a stack of arc plates for each arc chamber, where each arc chamber has a pair of magnets to generate opposite magnetic fields to drive an arc into a corresponding stack of arc plates depending upon the direction of the current.

Various problems with electrical switching apparatus, such as circuit breakers, and their proposed solutions often involve significant tradeoffs in terms of, for example, performance, size and cost. As a result, one solution or one set of solutions does not fit all applications. Also, many low volume markets exist for DC and AC switching applications that are not sufficient to support new product development and industrialization costs.

There is room for improvement in electrical switching apparatus.

### SUMMARY

These needs and others are met by embodiments of the disclosed concept in which an interchangeable switching module is added to an electrical switching apparatus to provide, for example and without limitation, a DC switching device, a relatively higher power AC switching device or another electronic switching device. This approach addresses low volume DC and AC markets by adding an engineered switching module to a standard product family in order to achieve the desired performance.

A non-limiting example interchangeable switching module, when used for a DC circuit breaker, can achieve 750 VDC bidirectional switching without major changes to the operating and trip mechanisms originally employed for AC switching applications.

In accordance with one aspect of the disclosed concept, an interchangeable switching module is for an electrical switching apparatus comprising a first enclosure, separable contacts and an operating mechanism structured to open and close the separable contacts. The interchangeable switching module comprises: a second enclosure structured to fit within the first enclosure of the electrical switching apparatus; and an interchangeable electrical circuit and/or mechanical mechanism within the second enclosure and being structured to cooperate with switching of the separable contacts.

As another aspect of the disclosed concept, an electrical switching apparatus comprises: a first enclosure; separable contacts; an operating mechanism structured to open and close the separable contacts; and an interchangeable switching module comprising: a second enclosure structured to fit within the first enclosure, and an interchangeable electrical circuit and/or mechanical mechanism within the second enclosure and cooperating with switching of the separable contacts.

As another aspect of the disclosed concept, an interchangeable switching module is for an electrical switching apparatus comprising a first enclosure and an operating mechanism structured to open and close separable contacts. The interchangeable switching module comprises: a second enclosure structured to fit within the first enclosure of the electrical switching apparatus; and an interchangeable electrical circuit and/or mechanical mechanism within the second enclosure, the interchangeable electrical circuit and/or mechanical mechanism comprising the separable contacts.

### BRIEF DESCRIPTION OF THE DRAWINGS

A full understanding of the disclosed concept can be gained from the following description of the preferred embodiments when read in conjunction with the accompanying drawings in which:

FIG. 1A is an isometric view of a DC miniature circuit breaker including an interchangeable DC arc chamber or arc chute including two stacks of arc splitting plates in accordance with embodiments of the disclosed concept.

FIG. 1B is an isometric view of the interchangeable DC arc chamber or arc chute of FIG. 1A.

FIG. 2 is a vertical end elevation view of the DC arc chamber or arc chute of FIG. 1B showing the magnetic field.

FIG. 3 is a sectional view of a portion of an interchangeable DC arc chamber or arc chute in accordance with another embodiment of the disclosed concept.

FIG. 4 is an exploded isometric view of the DC miniature circuit breaker of FIG. 1A showing the electrical and mechanical connections to the DC arc chamber or arc chute.

FIG. 5 is an isometric view of an enclosed gas-filled arc chamber in accordance with another embodiment of the disclosed concept.

FIG. 6 is an isometric view of an arc chamber including a scissors structure in accordance with another embodiment of the disclosed concept.

FIG. 7A is a block diagram in schematic form of two switching elements in parallel and a positive temperature coefficient (PTC) element in series with the second switching element in accordance with another embodiment of the disclosed concept.

FIG. 7B is a block diagram in schematic form of two switching elements in series and a PTC element in parallel with the second switching element in accordance with another embodiment of the disclosed concept.

FIG. 8 an isometric view of a DC arc chamber including an air blower and a stack of arc plates in accordance with another embodiment of the disclosed concept.

FIG. 9 is a block diagram of an interchangeable electrical circuit and/or mechanical mechanism in the form of a point-on-wave controller in accordance with another embodiment of the disclosed concept.

### DESCRIPTION OF THE PREFERRED EMBODIMENTS

As employed herein, the term “number” shall mean one or an integer greater than one (i.e., a plurality).

As employed herein, the statement that two or more parts are “connected” or “coupled” together shall mean that the parts are joined together either directly or joined through one or more intermediate parts.

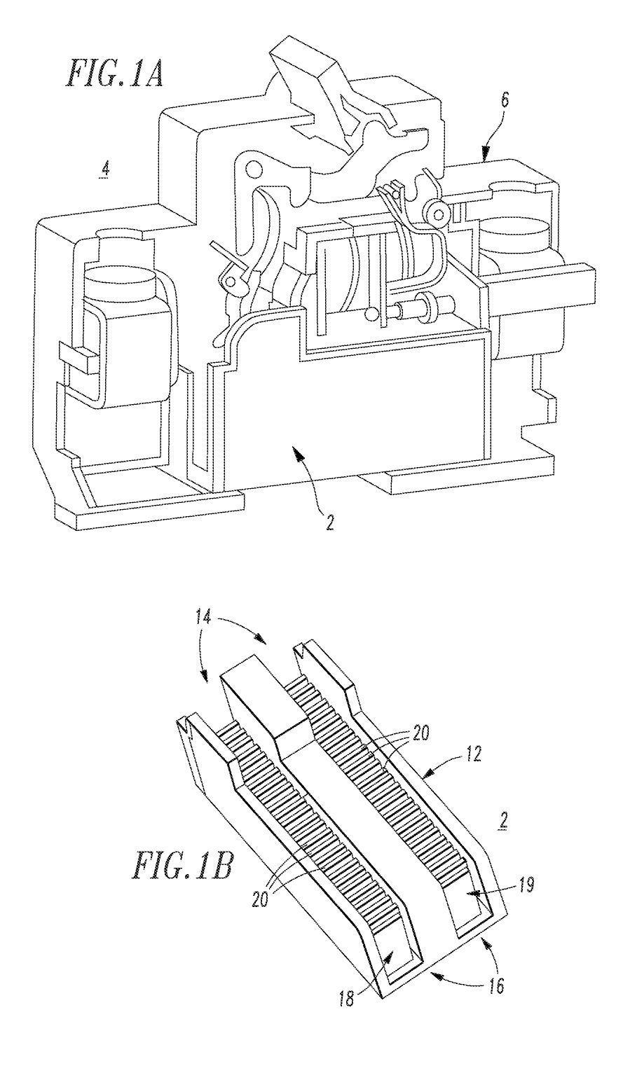

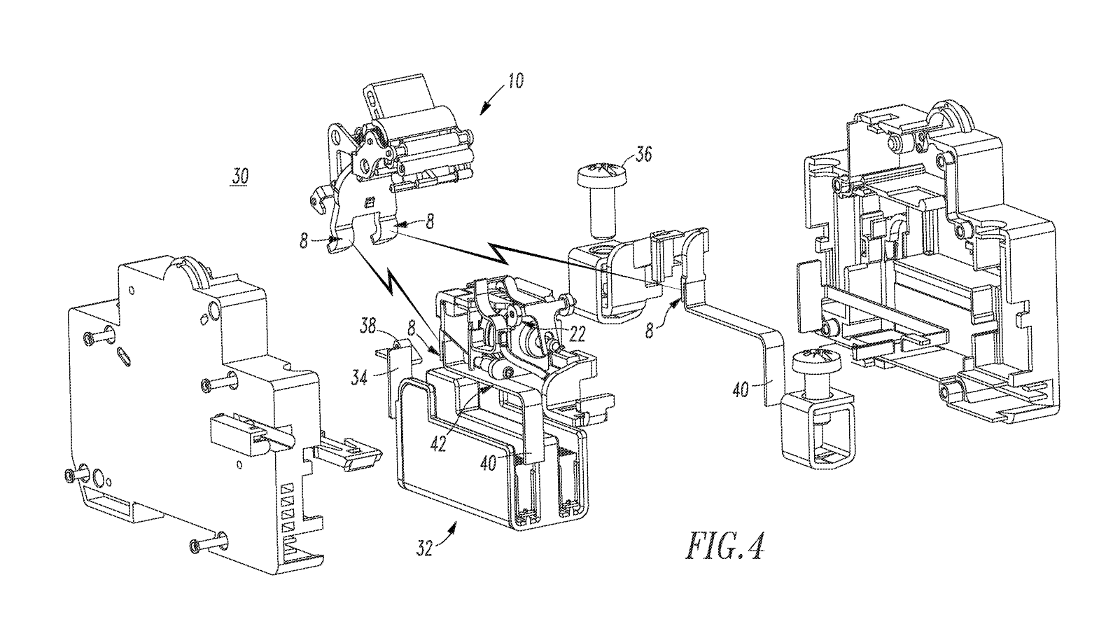

Referring to FIGS. 1A and 1B, an interchangeable switching module 2 is for an electrical switching apparatus 4 including a first enclosure 6, separable contacts 8 (shown in FIG. 4) and an operating mechanism 10 (shown in FIG. 4) structured to open and close the separable contacts 8. The interchangeable switching module 2 includes a second enclosure 12 structured to fit within the first enclosure 6 of the electrical switching apparatus 4, and an interchangeable electrical circuit and/or mechanical mechanism 14 within the second enclosure 12 and being structured to cooperate with switching of the separable contacts 8.

### Example 1

For a DC miniature circuit breaker application, a traditional AC arc chamber (not shown) is replaced by a specially developed interchangeable DC arc chamber or arc chute 16 that contains two stacks 18,19 of arc splitting plates 20. The new DC arc chamber 16 allows one of two arcs generated by the series-connected double break contacts 8 (FIG. 4) to be driven into one of the arc stacks 18,19 depending on the direction of current. This builds up a suitable high arc voltage to interrupt the DC current. In this example, there is no need for a redesign or change of the switching or operating mechanism 10 (FIG. 4) and the corresponding trip mechanism 22 (FIG. 4) that was originally applied for AC switching applications.

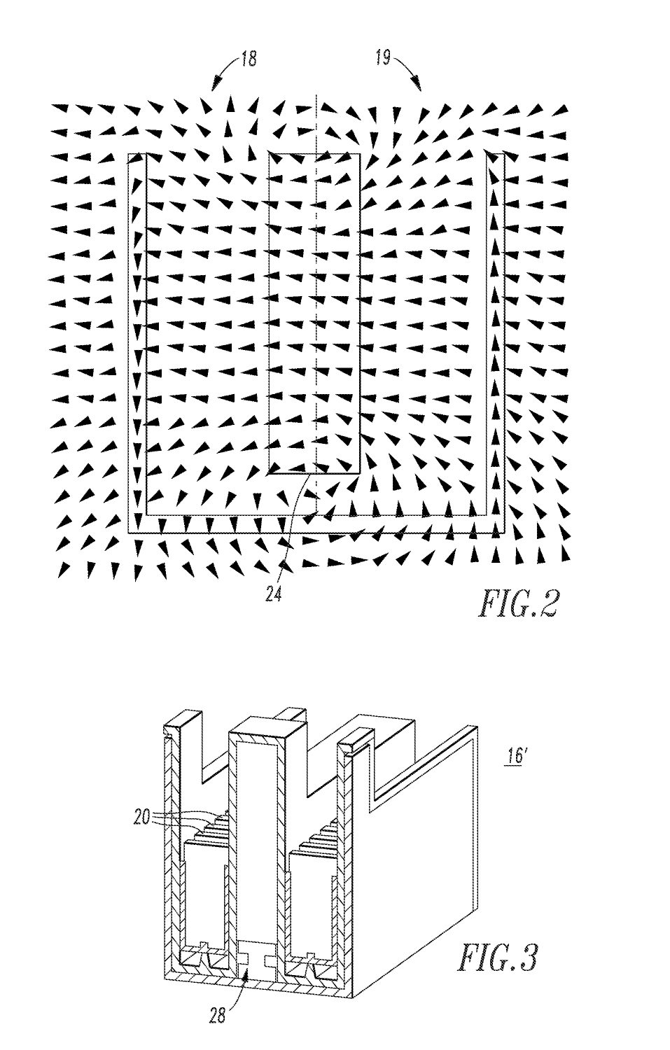

An example arrangement is shown in FIGS. 1A, 1B, 2 and 4. The magnetic fields are induced by a permanent magnet 24 (e.g., without limitation, a double-thick magnet 24 is shown) within the center barrier housing or second enclosure 12 of the two stacks 18,19 of arc plates 20. The magnetic fields have the same flux direction in both stacks 18,19 as shown in FIG. 2.

### Example 2

The operating mechanism 10 includes the trip mechanism 22 of FIG. 4 structured to trip open the separable contacts 8. The interchangeable electrical circuit and/or mechanical mechanism 14 cooperates with switching of the separable contacts 8 and/or with the trip mechanism 22.

### Example 3

The interchangeable electrical circuit and/or mechanical mechanism 14 is structured to cooperate with switching of the separable contacts 8 in series with an alternating current power circuit or a direct current power circuit.

### Example 4

The electrical switching apparatus 4 is selected from the group consisting of a switching device, a circuit breaker, a contactor, a manual motor starter, a relay, and a safety switch.

### Example 5

The interchangeable electrical circuit and/or mechanical mechanism 14 includes a number of first components. The electrical switching apparatus 4 further includes a number of second components. The second enclosure 12 either drops into the first enclosure 6, or the number of first components are welded or brazed to the number of second components.

### Example 6

The separable contacts 8 can be within the first enclosure 6 or the second enclosure 12, as will be described.

### Example 7

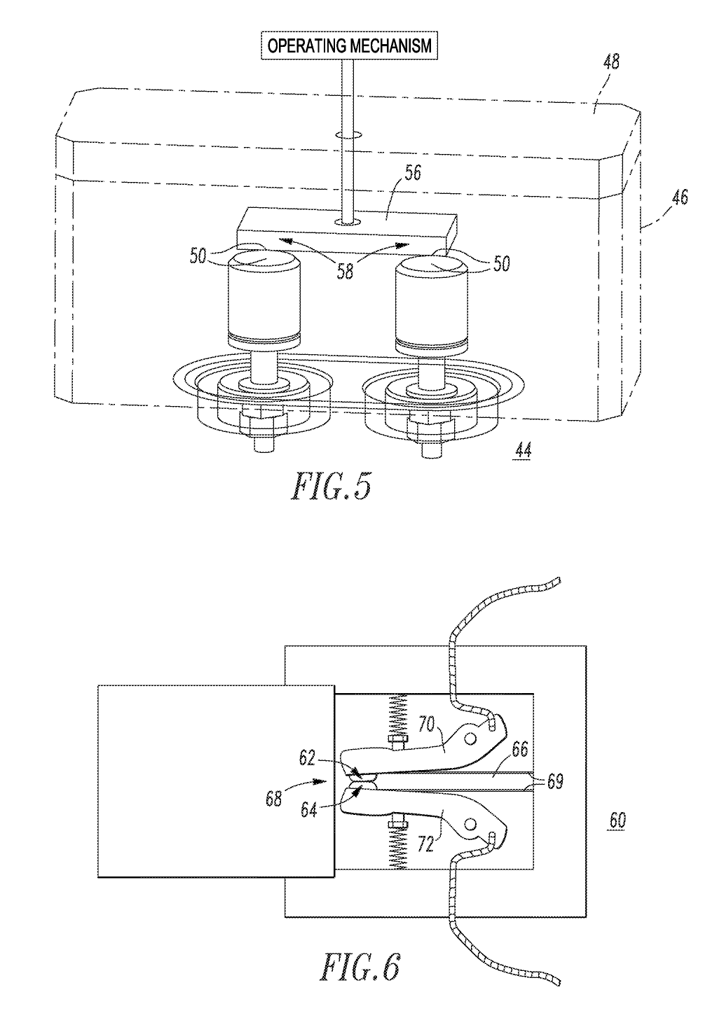

The interchangeable electrical circuit and/or mechanical mechanism 14 can include the separable contacts 8. See, for example, FIGS. 5, 6, 7A, 7B and 8, which are discussed below.

### Example 8

Referring to FIG. 3, a varistor 28 is electrically connected in parallel with a predetermined number of the stack arc plates 20 in order to limit the high transient voltage generated during inductive load interruption. This varistor 28 is placed in the interchangeable DC arc chamber 16′ as shown in FIG. 3. For example, if a switching device, such as the electrical switching apparatus 4 of FIG. 1A, needs a transient suppressor to function in an application, then the addition of a number of MOVs, resistor/capacitor networks, the example varistor 28 and the like can be added to the switching device in a variety of modular ways.

### Example 9

FIG. 4 shows electrical connections to a circuit breaker 30, which can be the same as or similar to the electrical switching apparatus 4 of FIG. 1A. An interchangeable DC arc chute 32, which can be the same as or similar to the interchangeable switching module 2 of FIG. 1B, is connected to the circuit breaker 30 by bolted connections such as where the arc plate 34 is electrically connected to the load terminal 36 by the jumper 38. Also, the connections to the arc chute 32 can be welded or brazed to the circuit breaker 30 like a portion 40 of the arc runner 42. A same or similar concept will work for adding a different AC interruption structure.

### Example 10

As shown in FIG. 5, an interchangeable DC arc chamber 44 is an enclosed arc chamber 46 (shown in phantom line drawing) containing special gas mixtures 48 (shown in phantom line drawing) that will generate high arc voltage to interrupt the DC current. The gas filled sealed arc interruption chamber 46 is something that can be added as an interchangeable switching module to address AC and DC applications where high levels of arc cooling (to generate high arc voltage) and high dielectric performance (to interrupt high system voltages or withstand high voltage spikes) are desired. This provides an interchangeable electrical circuit and/or mechanical mechanism having the enclosed gas-filled arc chamber 46 enclosing separable contacts 50. In this example, the separable contacts 50 are a double break translational contact system. Typically, a conventional single break contact structure (not shown) has a moving conductor that pivots about one end and has an electric contact at the other end (e.g., a rotational contact system). In contrast, a double break contact structure has a moving conductor 56 with an electric contact 58 at both ends (i.e., two contacts). In such a translational contact system, both of the contacts 58 are attached to the bottom (with respect to FIG. 5) of the moving conductor 56, which moves in an upward (with respect to FIG. 5) direction to open (separate) the contacts 50.

### Example 11

Referring to FIG. 6, an interchangeable electrical circuit and/or mechanical mechanism, such as the example interchangeable DC arc chamber 60, has a number of structures 66,68 that physically stretch and squeeze an arc, for example and without limitation, like a scissor to cool the arc and, therefore, generate high arc voltage. The interchangeable DC arc chamber 60 functions to interrupt relatively high voltages and relatively low current DC and AC conditions. The interchangeable DC arc chamber 60 includes an insulator 66 structured to slide between separable contacts 62,64 and a relatively narrow channel 69 and force an arc therebetween to become relatively longer and be cooled by proximity to the insulator 66. The insulator 66 for the scissors structure 66,68 is located between the two movable conductors 70,72. The insulator 66 moves to the left (with respect to FIG. 6) between the separable contacts 62,64 when the contacts separate. Both of the two movable conductors 70,72 and the scissors insulator 66 are connected to a trip mechanism (not shown).

### Example 12

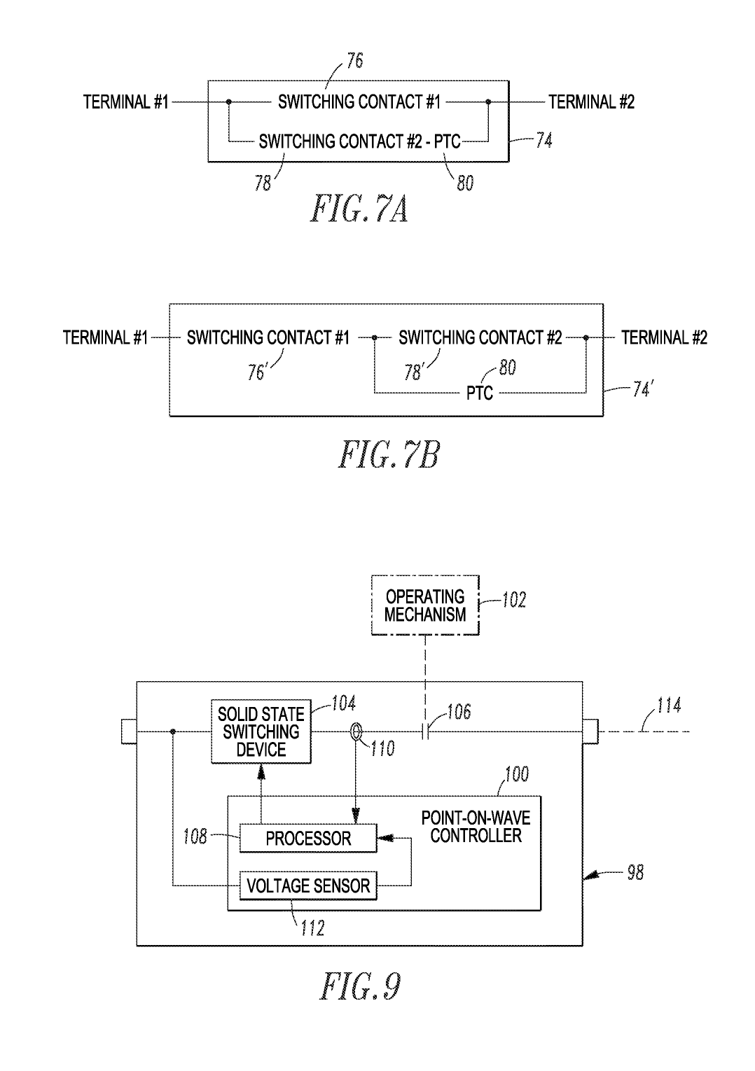

As shown in FIG. 7A, an interchangeable DC arc chamber 74 has a solid state switching device 76 (shown as switching contact #1), for example and without limitation, such as an IGBT, in parallel with separable mechanical contacts 78 (shown as switching contact #2). Once the separable mechanical contacts 78 separate, the arc voltage will drive the DC current through the parallel solid state switching device 76. Then, the DC current will be interrupted by the solid state switching device 76. The separable mechanical contacts 78 can be part of an electrical switching apparatus, such as a switching device, or can be part of the interchangeable DC arc chamber 74, as shown.

A positive temperature coefficient (PTC) device 80 can be a number of PTC elements including a switching element (not shown) to improve the switching capability of the separable mechanical contacts 78, such as electro-mechanical switches. A PTC element is a strongly non-linear element, which heats up by the current flowing therethrough. If a certain “triggering point” is reached, then the resistance of the PTC element increases by some orders of magnitude.

As shown in FIGS. 7A and 7B, there are two ways to apply the PTC element 80. In FIG. 7A, a first switching contact, the solid state switching device 76, minimizes the “on” losses of the total system. The series combination of a second switching contact, the separable mechanical contacts 78, and the PTC device 80 are electrically connected in parallel with the first switching contact and provide mechanical opening of the electrical circuit (e.g., an insulating switch function). If the corresponding switch device is closed, then both of the first and second switching contacts 76,78 are closed. If the corresponding switch device is opened, at first, the first switching contact 76 is opened and the current commutates into the path of the second switching contact 78. Then, the PTC device 80 triggers and, thus, the total current drops below the minimum arc current. Finally, the second switching contact 78 is opened with minimal arcing process.

In FIG. 7B, a similar switching principle is employed. In order to open the electrical circuit, the second switching contact 78′ is opened first. The current should commutate to the parallel PTC device 80. After the triggering of the PTC device 80, the first switching contact 76′ should be opened in order to provide galvanic separation. Again, the separable mechanical contacts 78′ can be part of an electrical switching apparatus, such as a switch device, or can be part of the interchangeable DC arc chamber 74′.

FIGS. 7A and 7B both have advantages and disadvantages. For FIG. 7A, the first switching contact 76 carries the main current only. The “on” losses of the system are influenced by only the first switching contact 76. Both of the first and second switching contacts 76,78 have to provide galvanic separation.

For FIG. 7B, the “on” losses are influenced by both of the first and second switching contacts 76′,78′. Both of these switching contacts have to carry the main current. Here, the first switching contact 76′ has to provide galvanic separation only. Also, any switch in parallel with the PTC device 80, such as the second switching contact 78′, has to extinguish the arc at the residual voltage of the PTC device 80.

### Example 13

In FIG. 7B, the second switching contact 78′ can be separable mechanical contacts. The interchangeable electrical circuit and/or mechanical mechanism 74′ can include a capacitor (not shown) or the PTC device 80 in parallel with the separable mechanical contacts 78′.

### Example 14

In FIG. 7A, the second switching contacts are separable mechanical contacts 78. The interchangeable electrical circuit and/or mechanical mechanism 74 can include a solid state switching device 76 as the first switching contacts in parallel with the separable mechanical contacts 78.

### Example 15

In FIG. 7B, the first switching contacts are a solid state switching device 76′ that carries current flowing in a power circuit with less voltage drop than a corresponding voltage drop of the second switching contacts that are separable mechanical contacts 78′. The separable mechanical contacts 78′ open to provide galvanic isolation to the power circuit.

### Example 16

In FIG. 7A, the first switching contacts 76 can be separable contacts within the second enclosure 12 of FIG. 1B. The interchangeable electrical circuit and/or mechanical mechanism 74 further includes the series combination of the second switching contacts 78 and the PTC device 80. The series combination is in parallel with the first switching contacts 76.

### Example 17

In FIG. 7B, the first switching contacts 76′ can be separable contacts within the second enclosure 12 of FIG. 1B. The interchangeable electrical circuit and/or mechanical mechanism 74′ further includes the second switching contacts 78′ in series with the first switching contacts 76′ and the PTC device 80 in parallel with the second switching contacts 78′.

### Example 18

As an alternative to Example 12, in place of the solid state switching device 76, the parallel current path can be a capacitor or a PTC device.

### Example 19

Further to Example 12, the switching process can be controlled in a timely fashion (e.g., point-on-wave as will be discussed, below, in connection with FIG. 9), in order that both the solid state switching device 76 and the separable mechanical contacts 78 will see minimum arcing damage. This can be controlled by an electronic circuit and with inputs from on-board current and voltage sensors. The solid state parallel switching device 76 can be switched on or off for AC applications at a particular point-on wave that minimizes electrical transient effects or minimizes the device degradation per operation.

### Example 20

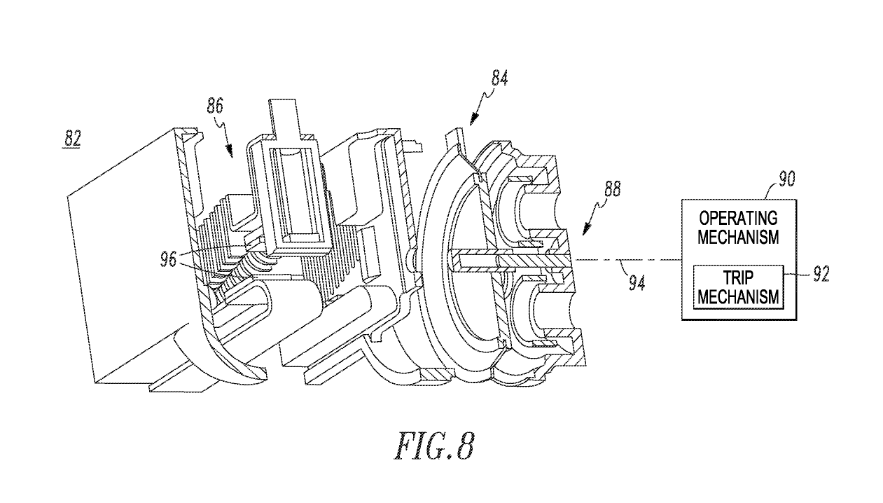

As shown in FIG. 8, an interchangeable DC arc chamber 82 is constructed with an air blower 84 and a stack of arc plates 86. The air blower 84 generates gas flow to push the arc into the stack of arc plates 86 and split the arc generating a relatively high arc voltage to interrupt the DC current. This can eliminate the need for expensive permanent magnets. Air blowers are common for relatively larger medium and higher voltage (e.g., 4 kV to about 50 kV) gas blast circuit breakers and switching devices (not shown). They are also common in some DC contactors and circuit breakers (not shown) for the rail industry to help with moving relatively low current arcs (where the magnetic field alone is not sufficient to move the arc).

As air flow moves the arc into the arc splitter plates 86 (see, also, the arc splitting plates 20 of FIG. 1B (e.g., 50% of air in the chamber is needed within 1.5 ms)), air flow generated with a piston 88 released by an operating mechanism 90 is employed to move relatively low-current arcs. For example, the air blower 84 is connected to a trip mechanism 92 of the operating mechanism 90 with a mechanical linkage 94. A double break translational contact system 96 includes a self-magnetic field for relatively higher currents.

### Example 21

FIG. 9 shows an interchangeable electrical circuit and/or mechanical mechanism 98 including a point-on-wave controller 100 cooperating with an operating mechanism 102 to minimize arcing damage to a solid state switching device 104 and separable mechanical contacts 106. The controller 100 includes a processor 108, a current sensor 110, and a voltage sensor 112 structured to switch the solid state switching device 104 on and off at a particular point-on-wave of an alternating current power circuit 114. The separable mechanical contacts 106 can be part of the mechanism 98 or can be part of an electrical switching apparatus (not shown) including the operating mechanism 102.

### Example 22

The interchangeable arc chamber modules, such as 2,16′,32,44,60,74,74′,82,98, disclosed herein can be designed and optimized for both AC and DC interruption.

### Example 23

The interchangeable arc chamber modules, such as 2,16′,32,44,60,74,74′,82,98, disclosed herein can be interchanged with each other without making changes of other parts of the electrical switching apparatus, such as 4.

### Example 24

The disclosed concept can be applied to all types of electrical switching apparatus, such as for example and without limitation, circuit breakers, contactors, manual motor starters, relays, and safety switches.

### Example 25

The various interchangeable modules, such as 2,16′,32,44,60,74,74′,82,98, disclosed herein need not be drop in (e.g., reusing a same connection mechanism that is part of a corresponding circuit breaker or other electrical switching apparatus). Instead, they can include parts that are welded or brazed to a common circuit breaker part. This could be allowed on a flexible production line where different copper parts are coupled to a common connection point.

### Example 26

For a DC circuit breaker (see, for example, FIG. 4), the arc runners of an existing AC circuit breaker (not shown) are modified, new copper parts are brazed on, and the arc chutes are replaced with a totally different DC structure. This may not involve mixing and matching parts to get different ratings. Instead, the approach can take advantage of the base design of movable, stationary, operating mechanism and trip mechanism parts, and then add other parts to achieve, for example and without limitation, desired AC performance, DC performance, or DC high inductive switching performance (e.g., without limitation, by adding MOVs).

### Example 27

Other non-limiting examples of interchangeable “modularity” include changing a magnetic trip solenoid (not shown) with an interchangeable hydraulic magnetic solenoid (not shown) to add temperature insensitive trip curves; an interchangeable interruption arc chute structure (not shown) to meet requirements of 277 VAC lighting protection systems; an interchangeable interruption arc chute structure (not shown) to meet high fault current unidirectional DC requirements for energy storage or electric vehicle applications; and a hybrid switching system (FIGS. 7A or 7B), where an arc chute is replaced with an interchangeable parallel solid state switching module to allow for the circuit breaker contact system to carry current when closed for a relatively low voltage drop and for the solid state switching module to interrupt the circuit. These examples allow a wide range of AC and DC performance ratings dependent only on the selection of the interchangeable switching module components.

Although separable contacts 8,50,62,64,96 are disclosed, suitable solid state separable contacts can be employed. For example, the disclosed electrical switching apparatus 4 includes a suitable circuit interrupter mechanism, such as the separable contacts 8 that are opened and closed by the operating mechanism 10, although the disclosed concept is applicable to a wide range of circuit interruption mechanisms (e.g., without limitation, solid state switches like FET or IGBT devices; contactor contacts) and/or solid state based control/protection devices (e.g., without limitation, drives; soft-starters; DC/DC converters) and/or operating mechanisms (e.g., without limitation, electrical, electro-mechanical, or mechanical mechanisms).

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. An interchangeable switching module for an electrical switching apparatus comprising a first enclosure, separable contacts and an operating mechanism structured to open and close said separable contacts, said interchangeable switching module comprising:
a second enclosure structured to fit within the first enclosure of said electrical switching apparatus; and
an interchangeable electrical circuit and/or mechanical mechanism within the second enclosure and being structured to cooperate with switching of said separable contacts.

2. The interchangeable switching module of claim 1 wherein said interchangeable electrical circuit and/or mechanical mechanism comprises a DC arc chamber or arc chute including two stacks of arc splitting plates and a permanent magnet.

3. The interchangeable switching module of claim 2 wherein said interchangeable electrical circuit and/or mechanical mechanism further comprises a varistor electrically connected in parallel with a predetermined number of the arc splitting plates.

4. The interchangeable switching module of claim 2 wherein said interchangeable electrical circuit and/or mechanical mechanism further comprises a transient suppressor selected from the group consisting of a number of MOVs, a varistor, and a resistor/capacitor network electrically connected in parallel with a predetermined number of the arc splitting plates.

5. An electrical switching apparatus comprising:
a first enclosure;
separable contacts;
an operating mechanism structured to open and close said separable contacts; and
an interchangeable switching module comprising:
a second enclosure structured to fit within said first enclosure, and
an interchangeable electrical circuit and/or mechanical mechanism within the second enclosure and cooperating with switching of said separable contacts.

6. The electrical switching apparatus of claim 5 wherein said interchangeable electrical circuit and/or mechanical mechanism comprises a DC arc chamber or arc chute including a stack of arc splitting plates and an air blower cooperating with said operating mechanism.

7. The electrical switching apparatus of claim 5 wherein said operating mechanism includes a trip mechanism structured to trip open said separable contacts; and wherein said interchangeable electrical circuit and/or mechanical mechanism cooperates with said trip mechanism.

8. The electrical switching apparatus of claim 5 wherein said interchangeable electrical circuit and/or mechanical mechanism comprises an insulator structured to slide between a contact scissors structure and a channel and force an arc therebetween to become relatively longer and be cooled by proximity to said insulator.

9. The electrical switching apparatus of claim 5 wherein said separable contacts are separable mechanical contacts; and wherein said interchangeable electrical circuit and/or mechanical mechanism comprises a capacitor or a positive temperature coefficient device in parallel with said separable mechanical contacts.

10. The electrical switching apparatus of claim 5 wherein said separable contacts are separable mechanical contacts; and wherein said interchangeable electrical circuit and/or mechanical mechanism comprises a solid state switching device in parallel with said separable mechanical contacts.

11. The electrical switching apparatus of claim 10 wherein said solid state switching device carries current flowing in a power circuit with less voltage drop than a corresponding voltage drop of said separable mechanical contacts; and wherein said state switching device and said separable mechanical contacts open to provide galvanic isolation to said power circuit.

12. The electrical switching apparatus of claim 10 wherein said interchangeable electrical circuit and/or mechanical mechanism further comprises a point-on-wave controller cooperating with said operating mechanism to minimize arcing damage to said solid state switching device and said separable mechanical contacts.

13. The electrical switching apparatus of claim 12 wherein said controller comprises a processor, a current sensor, and a voltage sensor structured to switch said solid state switching device on and off at a particular point-on-wave of an alternating current power circuit.

14. The electrical switching apparatus of claim 5 wherein said interchangeable electrical circuit and/or mechanical mechanism is structured to cooperate with switching of said separable contacts in series with an alternating current power circuit or a direct current power circuit.

15. The electrical switching apparatus of claim 5 wherein said electrical switching apparatus is selected from the group consisting of a switching device, a circuit breaker, a contactor, a manual motor starter, a relay, and a safety switch.

16. The electrical switching apparatus of claim 5 wherein said interchangeable electrical circuit and/or mechanical mechanism includes a number of first components; wherein said electrical switching apparatus further comprises a number of second components; and wherein the second enclosure drops into the first enclosure or said number of first components are welded or brazed to said number of second components.

17. The electrical switching apparatus of claim 16 wherein said separable contacts are within said first enclosure or said second enclosure.

18. An interchangeable switching module for an electrical switching apparatus comprising a first enclosure and an operating mechanism structured to open and close separable contacts, said interchangeable switching module comprising:
a second enclosure structured to fit within the first enclosure of said electrical switching apparatus; and
an interchangeable electrical circuit and/or mechanical mechanism within the second enclosure, said interchangeable electrical circuit and/or mechanical mechanism comprising said separable contacts.

19. The interchangeable switching module of claim 18 wherein said interchangeable electrical circuit and/or mechanical mechanism further comprises an enclosed gas-filled arc chamber enclosing said separable contacts.

20. The interchangeable switching module of claim 18 wherein said separable contacts are a first switch within said second enclosure; and wherein said interchangeable electrical circuit and/or mechanical mechanism further comprises a series combination of a second switch and a positive temperature coefficient device, said series combination being in parallel with said first switch.

21. The interchangeable switching module of claim 18 wherein said separable contacts are a first switch within said second enclosure; and wherein said interchangeable electrical circuit and/or mechanical mechanism further comprises a second switch in series with said first switch and a positive temperature coefficient device in parallel with said second switch.

22. The interchangeable switching module of claim 18 wherein said separable contacts are a double break translational contact system within said second enclosure.
